(19) United States
(12) Patent Application Publication
(10) Pub. No.: US 2026/0317222 A1
(43) Pub. Date: Oct. 15, 2026

(54) HIGH EFFICIENCY PROCESSING SYSTEM FOR GLASS SHEETS

(71) Applicant: SYSTEM CERAMICS S.P.A., FIORANO MODENESE (MODENA) (IT)

(72) Inventors: MARCO POGGI, FIORANO MODENESE (MODENA) (IT); GIULIANO PISTONI, FIORANO MODENESE (MODENA) (IT)

(21) Appl. No.: 19/485,471

(22) PCT Filed: May 14, 2024
(86) PCT No.: PCT/IB2024/054667

§ 371 Date: Nov. 18, 2025

(30) Foreign Application Priority Data
May 26, 2023 (IT) 102023000010692

(51) Int. Cl. C03B 33/037

(52) U.S. Cl. CPC C03B 33/037

(57) ABSTRACT

A processing system for sheets that includes a mobile table, a device for cutting sections having a shape and real dimensions from a sheet and including an optimisation algorithm integrated with a cutting means, a machining device configured to perform machining the shape, a printing unit configured to receive as input a set of images of expected dimensions and to dispense ink onto the shape, a drying device for drying the ink, a recognition unit having a plurality of sensors configured to detect the shape, a matching unit configured to match an image belonging to the set of images to the shape detected by the recognition unit, an alignment unit configured to detect the presence of a rotation angle between the section and the main conveyance direction and a control unit receiving the image, real dimensions, expected dimensions, and angle and to send operating commands to the printing unit.

The object of the present invention is a high efficiency processing system for glass sheets.

During the processing process, the glass sheets undergo successive processing steps, which are necessary to obtain the finished products. The finished products are glass, of different dimensions and shapes depending on the intended use.

Typically, the processing of glass sheets involves the following steps: cutting, machining, decorating, drying and tempering.

Firstly, a desired section is cut from a glass sheet, using glass-cutting machines and tools which exploit technologies known in the field of glass processing. Such a section is typically very similar in shape and dimensions to the final product, but requires further processing.

The section obtained has not yet reached the exact dimensions and final features required for its use.

Subsequently, the section obtained from the initial sheet is subjected to machining, which is necessary to finish edges or surfaces of the section. The machining step can occur by means of grinding or milling or other processes capable of removing parts of the glassy material by rubbing discs or abrasive components of higher hardness.

After being subjected to machining, the section represents the substrate for subsequent processing.

However, after a certain number of grinding cycles, the abrasive discs tend to wear out, losing effectiveness: the result is a lower abrasive power and, consequently, a lower capacity to remove glassy material from the edges of the section obtained.

Therefore, for the same duration of a machining cycle, non-worn abrasive discs will remove more material, while more worn abrasive discs will remove less material. It follows that the substrate obtained after the machining has variable final dimensions within a tolerance threshold, depending on the operating conditions of the abrasive discs.

The next step is that of decorating the substrate.

In the prior art, the substrate is decorated by means of digital ink-jet printing: the ink is dispensed from nozzles belonging to printing heads and deposited on the substrate; the printing heads are placed side by side to form a printing bar.

Patent application number 201800009570, filed on behalf of the same Applicant, illustrates a device for decorating glass sheets by means of ink-jet printing. In addition to describing the steps for digital ink-jet printing glass sheets, the document introduces a sheet preheating step: the aforesaid preheating step occurs before the ink is dispensed by the nozzles. Such a preheating step results in a faster drying of the deposited ink.

Therefore, a substrate preheating step is also known in the art.

Subsequently, the decorated substrate is subjected to final ink drying and tempering, so as to obtain, at the end of the process, an appropriately decorated substrate according to the applications and provided with adequate mechanical features.

The processing process starting from glass sheets has some critical elements.

Firstly, the glass processing processes known in the art generate a non-negligible amount of scraps in the cutting step, scraps which leads to waste in terms of materials and in economic terms.

Furthermore, during the decorating step, one of the requirements for the print to be completed in a qualitatively adequate manner is that the selected image be printed on the substrate at a predetermined resolution; furthermore, the image must be correctly printed, in terms of position and rotation with respect to the substrate to be decorated.

However, the result of the machining, as mentioned in the previous paragraphs, results in some variability in the substrates obtained, in terms of final shape and dimensions. Although such variations fall within a tolerance range which allows the substrate to be used, however, the print of an image may not perfectly match the substrate obtained. The same print settings, for example, may be perfectly functional for decorating a substrate ground with non-worn abrasive discs and vice versa, they may not be precise enough for a substrate ground with more worn abrasive discs.

Furthermore, in the prior art, the processing of substrates, and in detail the printing step, occurs by taking one substrate at a time, which is inefficient in terms of yield and productivity. Consequently, the entire processing process and, in particular, the substrate printing step, can be improved.

In light of the above considerations, the performance of glass substrate printing machines and the relative control systems can certainly be improved in order to achieve high performance in terms of output quality, precision and printing efficiency, while limiting the amount of scrap products.

Furthermore, in the light of the same considerations, the entire processing process starting from glass sheets can be improved from an efficiency point of view.

The object of the present invention is to provide a processing system for glass sheets and for printing glass substrates which can overcome the limits of the prior art.

Features and advantages of the present invention will more fully emerge from the following detailed description of an embodiment of the present invention, as illustrated in a non-limiting example in the accompanying figures, in which:

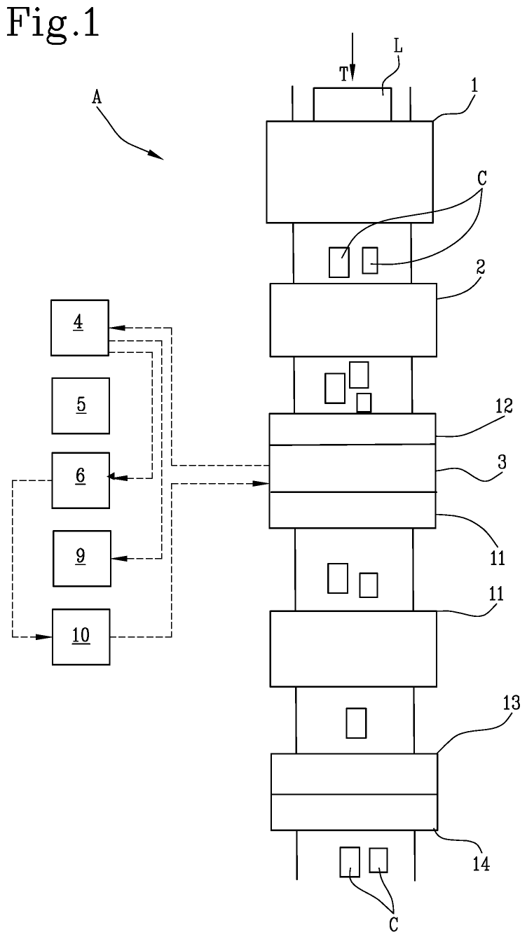

FIG. 1 shows a top view of the processing system according to an embodiment, in a simplified depiction.

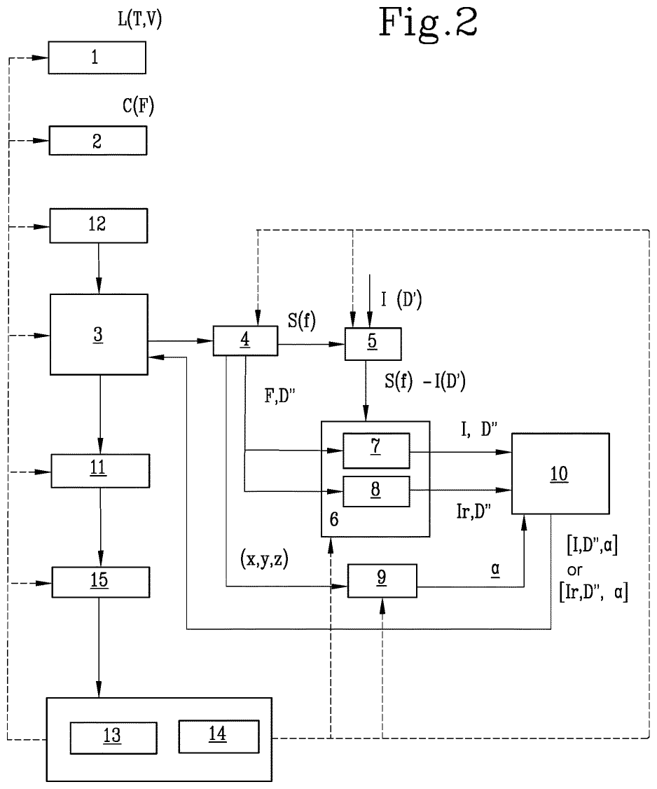

FIG. 2 shows a schematic depiction of the operation of the processing system of FIG. 1.

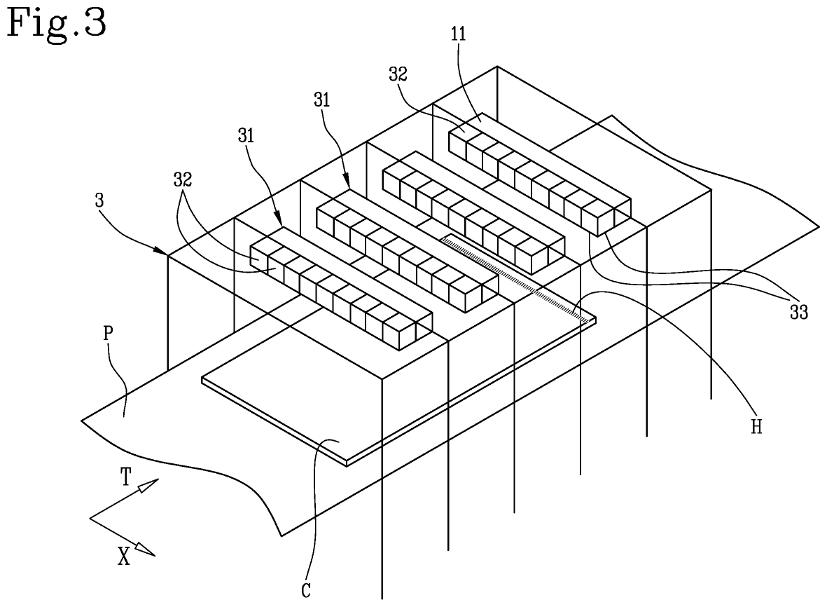

FIG. 3 shows an embodiment of a printing unit comprised in the processing system of FIG. 1.

The object of the present invention is a high efficiency processing system for glass sheets with high quality output.

In the course of the present disclosure, the term “sheet” is intended as a sheet-like glass object comprising two main faces, one upper and one lower, and a plurality of lateral sides, in which the distance between the main faces is considerably less than the distance between the lateral sides; the term “section” is intended as a portion derived from cutting a sheet; “printing” preferably is intended as a digital ink-jet printing process of a type known in the art, where an image is received as input and, through the action of an operating unit, controls the dispensing of ink droplets onto a substrate in determined positions to reproduce the image received as input on the aforesaid substrate. Lastly, “shape” is intended as the spatial configuration of an object, attributable to the traditional shapes of geometry or combinations thereof.

Advantageously, the processing system according to the present invention allows to reduce the amount of scrap products, and therefore waste.

Advantageously, the processing system according to the present invention allows to obtain prints of images on substrates having different shapes and dimensions, matching each substrate with the respective decoration. Advantageously, the processing system according to the present invention allows to adapt the images, and therefore the decorations to be applied to a substrate, to those dimensions variations dependent, for example, on the machining process.

Advantageously, the processing system according to the present invention allows to rotate images, so as to adapt the printing to the orientation of the substrate.

Advantageously, the processing system according to the present invention allows to perform such a printing process on several substrates simultaneously.

FIG. 1 shows a simplified depiction of an embodiment a high efficiency processing system (A) for sheets, comprising a plurality of processing machines, arranged in succession. The simplified depiction of FIG. 1 refers to a preferred, but not exclusive, embodiment of the system (A) according to the present invention.

The system (A) comprises a mobile table (P), having a conveyance direction (T);

A sheet (L) is moved on the mobile table (P) along the conveyance direction (T).

The mobile table (P), according to a first embodiment, comprises a conveyor belt associated with a movement means, arranged to move the sheet (L) on the outer surface of the conveyor belt: the result is the translation of such a sheet (L) in a conveyance direction (T) at a conveyance speed (V).

In an alternative embodiment, the mobile table (P) comprises a succession of cylindrical rollers arranged parallel to each other and perpendicular to the conveyance direction (T); such rollers are associated with a movement means configured to move the sheet (L) on their outer surface, causing the translation of such a sheet (L) in the conveyance direction (T) at the conveyance speed (V).

The movement means associated with the mobile table (P) are configured to allow, very advantageously, to translate the sheet (L) while minimising unwanted oscillations and vibrations, which could interfere with the integrity of the sheet and the final quality of the decoration.

The sheet (L), coming from stations located upstream of the system (A) considering the conveyance direction (T), is positioned on the mobile table (P) in order to be subjected to the following processing steps, illustrated below. The aforesaid upstream stations can be processing stations, storage warehouses, conveyors or movement means or UGVs.

The first processing step according to the present invention is a high efficiency cutting step, operated by a cutting device (1).

The cutting device (1) is configured to cut the sheet (L) conveyed by the mobile table (P) into a plurality of sections (C).

According to the object of the present invention, the cutting device (1) is advantageously optimised by means of a control system, which is configured to obtain several sections (C) within a sheet (L). That is, the object of the present invention comprises an algorithm integrated with the control system of the cutting device: the aforesaid algorithm is configured to cut a plurality of sections (C) within the sheet (L).

The sections (C) obtained from a sheet (L) may all have the same shape or they may assume different shapes.

The algorithm integrated into the control system is otherwise said nesting algorithm: the algorithm receives as input the dimensions of the surface (S) of the sheet (L) and the shape (F) of each section (C) to be cut, processes the combination of sections (C) most capable of optimising the surface of the sheet (L) and sends, by means of the control device, operational commands to the cutting tools on the basis of the processed combination of sections (C).

The plurality of sections (C) identified within the sheet (L) by the nesting algorithm allows to very advantageously produce a reduced amount of scrap elements.

Applying the nesting algorithm, it is advantageously possible to reduce material waste, exploiting the entire surface(S) of the sheet (L).

The cutting operation occurs, preferably but not exclusively, by a CNC or Computer Numerical Control type cutting machine. CNC-type cutting machines are known in the art.

It is possible to obtain a plurality of sections (C) from the sheet (L), which are subjected to subsequent processing steps.

Following the cutting step, the sections (C) are conveyed from the mobile table (P) along the conveyance direction (T) towards one or more machines configured for the machining.

Downstream of the cutting step, each section (C) is finished by means of machining.

A machining device (2) comprises abrasive elements, preferably discs or other suitably shaped elements, which operate on the surface of the section (C) and, preferably, along edges and corners so as to make them smoother and more manageable; according to other embodiments, the machining serves to impart particular surface properties to each section (C) cut from the sheet (L).

Furthermore, the machining can also affect the inner portions of the section (C), removing material even through the thickness of the inner portion of the section (C); the machining machine (2) is, therefore, also configured to perform this type of action on the section (C)

The machining can occur by means of grinding, milling or other techniques known in the art which are configured to modify the appearance, dimensions, or surface or inner features of the sections (C).

Typically, these operations involve the removal of glassy material to finish the sections (C); for example, the machining device (2) allows to remove sharp edge portions, so as to make each section (C) safer to grip and more manageable.

Furthermore, the machining device (2) allows to remove glassy material within the surface of each section (C), so as to obtain inner voids; the aforesaid inner voids can assume different dimensions and geometries. In detail, the inner voids can fulfil a function or can confer a preferred aesthetic character to the section (C).

In this case, the machining step, in other words, results in the removal of glassy material even through the thickness of the section (C).

Machining at the edges of the section (C) and machining within the section (C) can be advantageously combined by the machining device (2).

As mentioned in the preceding paragraphs, the abrasive elements can become worn after a certain number of working cycles; therefore, the sections (C) processed with non-worn abrasive elements will, for the same amount of time, experience greater material removal than sections (C) abraded with more worn elements.

Consequently, for the same shape (F), the dimensions of each section (C) may vary within a tolerance, due to the machining process by the machining device (2).

Subsequently, the plurality of sections (C) is moved along the conveyance direction (T) towards a printing unit (3).

The printing unit (3), located downstream of the machining device, receives the plurality of sections (C) as input.

The printing unit (3) is configured to decorate each of the sections (C), in single pass mode. That is, the decoration of the sections (C) occurs without interrupting their conveyance on the mobile table (P).

According to the present invention, the sections (C) are conveyed on the mobile table (P) without being arranged in a precise order and without being aligned with each other: several sections (C) can simultaneously be conveyed towards a printing unit (3). In the processing system subject-matter of the present invention, the printing unit (3) firstly comprises a recognition unit (4) of the shape (F) of the sections (C) and a matching unit (5).

The recognition unit (4) comprises a plurality of sensors configured to detect the shape (F) of each of the sections (C) entering the printing unit (3); the sensors are, for example, but not exclusively, image sensors. Preferably, but not exclusively, the recognition unit (4) comprises an imaging system comprising at least one camera. Other detection and imaging tools known in the art may also be used.

The shape (F) of each section (C) can be defined by a set of parameters, such as lengths of sides and amplitudes of angles comprised therebetween; that is, the aforesaid set of parameters uniquely defines the specific shape (F) of a section (C): sections (C) having different shapes (F) have different sets of parameters.

Expected dimensions (D′) are defined as the values assumed by the set of parameters defining the shape (F) of the section (C) under optimal machining conditions; that is, under ideal conditions, with non-worn abrasive means, the values assumed by the aforesaid set of parameters correspond to the expected dimensions (D′) of the shape (F).

Conversely, real dimensions (D″) are defined as the values assumed by the same set of parameters under non-ideal machining conditions; an example of non-ideal machining conditions is when the abrasive discs used in the machining process are worn. In this specific case, worn discs remove less glassy material, therefore the real dimensions (D′) are larger than the expected dimensions (D′).

Wear is one of the causes which can determine, at the end of the machining process, expected dimensions (D′) which differ from the real dimensions (D″); other phenomena, not listed here, but easily intuited by the person skilled in the art, can interfere with the machining process, affecting the real dimensions (D″) of each section (C).

The recognition unit (4) is thus further configured to detect the real dimensions (D″) of each section (C); in fact, the recognition unit (4) comprises a data acquisition and processing system configured to detect the real dimensions (D″) of each section (C) of shape (F). Preferably, the imaging system comprises at least one camera; alternatively, the imaging system comprises imaging and detection systems of other type, known in the art.

The shape (F) detected for each section (C) is transduced into a shape signal (S(f)), which is sent to the matching unit (5). That is, the shape (F) allows to establish the matching of the section (C) to the corresponding image (I) by the matching unit (5), as described in the following paragraphs.

The matching unit (5) is configured to match each shape signal (S(f)) with a respective image (I): in this step, each section (C) is advantageously matched with the correct decoration, corresponding to the correct image (1), chosen within a database based on the shape (F) of the section (C) itself.

Very advantageously, the object of the present invention allows to obtain the shape (F)-image (I) match for each section (C); the printing unit (3) automatically processes the aforesaid match and allows to decorate sections (C) of different shapes (F) with the corresponding images (I). Therefore, the process is efficient, versatile and not constrained to a specific shape (F).

Recognition units (4) and matching units (5) are configured to operate in series by detecting shapes (F) and real dimensions (D″) of sections (C) arranged in succession on the mobile table (P) along the conveyance direction (T).

Recognition units (4) and matching units (5) are also configured to operate in parallel, detecting shapes (F) and real dimensions (D″) of sections (C) arranged in parallel on the mobile table (P) along the conveyance direction (T).

Lastly, recognition units (4) and matching units (5) are configured to operate by detecting shapes (F) and real dimensions (D″) of sections (C) arranged differently on the mobile table (P).

The printing unit (3) according to the present invention further comprises a processing unit (6), arranged to adapt the image (I) matched to the section (C) by the matching unit (5) to the specific section (C) crossing through the printing unit (3).

In order to adapt the image (I) to be printed on each section (C) having shape (F), the processing unit (6) advantageously comprises at least one among:
a scaling unit (7)
a trimming unit (8).

That is, the processing unit (6) may comprise the scaling unit (7) alone, or the trimming unit (8) alone, or both the scaling unit (7) and the trimming unit (8).

Still in other words, the system (A) according to the present invention comprises, in a first embodiment, a processing unit (6) comprising only the scaling unit (7). Alternatively, in a second embodiment, the system (A) according to the present invention comprises only the trimming unit (8). Still alternatively, in a third embodiment, the system (A) according to the present invention comprises both the scaling unit (7) and the trimming unit (8).

The scaling unit (7) and the trimming unit (8) are configured to perform, in different manners, an adaptation of the image (I) to the specific shape (F) of the section (C).

The scaling unit (7) and the trimming unit (8), if both are present in the processing unit (6), are alternately activated by an operator; that is, depending on the final print to be obtained on the section (C), the operator can decide to activate either the scaling unit (7) or the trimming unit (8).

In fact, the purpose of the processing unit (6) is to obtain a print of the image (I) perfectly adapted to the specific geometric features of each section (C), taking into account the specific shape (F).

The operation of the aforesaid trimming and scaling units (7,8) is detailed in the following paragraphs.

The scaling unit (7) is configured to adapt the dimensions of the image (I), matched to the shape (F) by the matching unit (5), to the real dimensions (D″) of the section (C) of the shape (F).

Therefore, the scaling unit (7) receives the information transmitted by the recognition unit (4): in particular, the scaling unit (7) is configured to receive the information related to the real dimensions (D″) acquired and transmitted by the processing unit (4).

A scaling algorithm, which is integrated into the scaling unit (7), is configured to compare the real dimensions (D″) with the expected dimensions (D″) of the section (C) of shape (F) and to perform a scaling of the image (I) on the basis of the real dimensions (D″).

That is, the scaling algorithm is advantageously configured to perform a controlled total or partial distortion of the aforesaid image (I).

One of the methods which can be used by the scaling algorithm involves dividing the image into a grid or mesh of triangles, each of which represents a unit on which scaling or distortion operations can be performed.

The present disclosure will not go into the details of operation of the scaling algorithm.

That is, the scaling unit (7) is advantageously arranged to adapt the image (I) to the shape (F) and, in particular, to its real dimensions (D″): for sections (C) with real dimensions (D″) larger than the expected dimensions (D″), the image (I) is distorted by enlargement, for sections (C) of real dimensions (D″) smaller than the expected dimensions (D″), the image (I) is distorted by reduction.

In the following paragraphs, reference will be made to the term “scaling” to indicate the action of adapting the image (I) performed by the scaling unit (7).

The trimming algorithm (8), on the other hand, is configured to perform adaptation of the image (I) without distorting it once it has been printed on the section (C). The trimming algorithm (8) works by refining or, in other words, cutting out portions of the image (I) to be printed on the section (C). That is, if a section (C) having shape (F) has smaller real dimensions (D′) than the expected dimensions (D′), a trimming algorithm, integrated in the trimming unit (8), is configured to crop the image (I), so as to obtain a trimmed image (Ir), based on the real dimensions (D′) detected.

Unlike what was described for the scaling unit (7), the trimming unit (8) operates by removing parts of the image (I); preferably, but not exclusively, the trimming algorithm operates by trimming or, in other words, cropping portions of the image (I) so as to obtain the trimmed image (Ir). That is, by means of the trimming unit (8), the edges of the image (I) can be advantageously cropped and are consequently not printed by the printing unit (3).

Therefore, the trimming unit (8) receives the information transmitted by the recognition unit (4): in particular, the trimming unit (8) is configured to receive the information related to the real dimensions (D″) acquired and transmitted by the processing unit (4).

Therefore, the trimming algorithm integrated in the trimming unit (8) advantageously allows the trimmed image (Ir) to be obtained, which perfectly matches the real dimensions (D″) of the respective section (C). The trimming algorithm will not be described in detail in the present disclosure, but is introduced here from a functional perspective.

In the following paragraphs, reference will be made to the term “trimming” to indicate the action of adapting the image (I) performed by the trimming unit (8).

The effect obtained at the end of the printing step, in the case of trimming, is deliberately different from the effect which would be obtained by scaling: by means of the trimming algorithm, a part of the image (I) is necessarily removed to obtain the trimmed image (Ir). Therefore, the scaling units (7) and trimming units (8) represent two different and alternative methods for adapting the image (I) to the section (C), which can be selected in advance by the operator depending on the result to be obtained.

In conclusion, therefore, the scaling unit (7) and the trimming unit (8), after having determined the necessary scaling or desired trimming of the image (I), allow to send operational commands to the printing unit (3), so that the image (I), re-adapted to the real dimensions (D″) according to the method selected by the operator, is correctly printed on the respective section (C). The printing unit (3) subject-matter of the present invention further comprises an alignment unit (9), configured to determine the correct positioning of the image (I) or trimmed image (Ir) on each section (C).

In fact, when exiting the cutting device (1) and the machining device (2), the alignment of the sections (C) with respect to the conveyance direction (T) is not checked. That is, considering the conveyance direction (T), the sections (C) could be perfectly aligned and ready to receive the printing ink, or they could be misaligned with the conveyance direction (T).

Without the alignment unit (9), the image (I) or the trimmed image (Ir) would not be perfectly printed on the respective section (C), but rotated by an angle (α) which is greater the more the section (C) is rotated with respect to the expected alignment with respect to the conveyance direction (T)

The alignment of the sections (C) with respect to the conveyance direction (T) can be verified in various ways, with sensor systems and algorithms known to the person skilled in the art.

An example of a method for detecting the alignment of a substrate within a printing machine is disclosed in patent application number 102016000022779 in the name of the same Applicant; the aforesaid patent application illustrates not only a method for detecting the alignment of a substrate, but also a method for rotating the image to be printed on the substrate, so as to compensate for any misalignment of the substrate with respect to the conveyance direction (T).

According to this method, a reference system is defined to refer to the coordinates of the substrate to be printed moving along a printing direction through a printing machine. Such coordinates are compared with a set of virtual coordinates, attributed to an image to be printed: the virtual coordinates correspond to the correct alignment of the substrate with respect to the printing direction.

If the two sets of coordinates coincide, no correction is made. Conversely, if the two sets of coordinates do not coincide, an algorithm determines the rotation of the image so that it is printed correctly on the substrate.

With reference to the alignment unit (9) subject-matter of the present invention, a suitably chosen reference system allows to detect a set of real coordinates (x, y, z) identifying the section (C) on which a printing operation is to be performed; such a section (C) is moved by the mobile table (P) in the conveyance direction (T) through the printing unit (3).

Each section (C) corresponds to an image (I), attributed by the matching unit (5), scaled by the scaling unit (7) or trimmed by the trimming unit (8): a set of virtual coordinates (xv, yv, zv) is attributed to such an image (I) or trimmed image (Ir), corresponding to the correct alignment of the section (C) along the conveyance direction (T).

If the set of real coordinates (x, y, z) and the set of virtual coordinates (xv, yv, zv) coincide, the alignment unit (9) does not perform any operation; conversely, if the set of real coordinates (x, y, z) and the set of virtual coordinates (xv, yv, zv) do not coincide, identifying an angle (α) of rotation between the two sets, the alignment unit (5) determines a rotation of the image (I) or the trimmed image (Ir), of the same angle (α) around the main axis thereof.

Very advantageously, the action of the scaling unit (7) or trimming unit (8) and alignment unit (9) allow to obtain a high-precision printing of images (I) on sections (C); in some sectors, including motor vehicle production, it is essential to obtain the most accurate glass printing possible, so as not to impair the driving experience and to protect critical components and connecting elements from the action of UV radiation.

The scaling unit (7), trimming unit (8) and alignment unit (9) are configured to operate on sections (C) arranged in series on the mobile table (P). The scaling unit (7), trimming unit (8) and alignment unit (9) are also configured to operate on sections (C) arranged in parallel on the mobile table (P). Lastly, the scaling unit (7), trimming unit (8) and alignment unit (9) are configured to operate on sections (C) arranged differently on the mobile table (P).

Furthermore, the printing unit (3) according to the present invention has a control unit (10), which is configured to receive information in input from the matching unit (5), the scaling unit (7) or the trimming unit (8) and the alignment unit (9).

That is, the matching unit (5) sends information to the control unit (10) related to the shape (F)-image (I) match for each section (C); furthermore, depending on the adaptation mode of the image (I) to the matching section (C), the scaling unit (7) or the trimming unit (8) communicates information to the control unit (10) related to the image to be printed on the respective section (C); finally, the scaling unit (9) sends information to the control unit (10) related to the possible rotation (α) to be performed on the image (I) or trimmed image (Ir) prior to the printing operation. The control unit (10) processes the aforesaid information and sends a direct printing command to at least one printing bar (31).

With reference to FIG. 3, the printing unit (3) comprises at least one printing bar (31) located above the mobile table (P); each printing bar (31) in turn comprises a plurality of printing heads (32) connected to an ink reservoir and placed side by side in a direction perpendicular to the conveyance direction (T).

Each printing head (32) comprises a plurality of nozzles (33), configured to dispense ink from above to below on each of the sections (C).

The nozzles (33) are digitally controlled by the control system (10).

That is, the control unit (10) processes the information received from the matching unit (5), the scaling unit (7) or the trimming unit (8), and the alignment unit (9) and, on the basis of this, sends an operating command to the printing bars (31); for each set of information [shape (F)-image (I) match; real dimensions (D′); adaptation mode of the image (scaling or trimming) to the section (C); angle (α)], the control unit (10) sends an activation command to the printing heads (32) and, in detail, to the individual nozzles (33), which are thus activated to dispense ink at a precise moment, corresponding to a precise position on the section (C).

The result is a high-precision print of an image (I) appropriately dimensioned and adapted on the basis of the real dimensions (D″) on each section (C).

Each printing bar (31) is located above the mobile table (P); preferably each printing bar (31) is arranged perpendicular to the conveyance direction (T). The ink is dispensed from the nozzles (33) belonging to the printing bar (31) towards the mobile plane (P), so that it is deposited on each section (C), defining a printing front (H).

That is, the printing front (H) of each printing bar (31) is identified by the ink dispensed by the nozzles (33) belonging to the printing bar (31), and is therefore also perpendicular to the conveyance direction (T).

The printing unit (3) can thus operate on sections (C) arranged in series on the mobile table (P) along the conveyance direction (T): when conveying each section (C) on the mobile table (P) in the conveyance direction (T), the printing front (H) of each printing bar (31) affects one section (C) at a time in this configuration.

The printing unit (3) can also operate on sections (C) arranged in parallel on the mobile table (P) along the conveyance direction (T).

According to this configuration, at least two sections (C) are placed side by side along a transverse direction (X), horizontal and perpendicular to the conveyance direction (T), and are advanced from the mobile table (P) in the conveyance direction (T). In this second configuration, the printing front (H) of each printing bar (31) affects at least two sections (C) moved through the printing unit (3). That is, the ink is dispensed by the nozzles (33) belonging to a printing bar (31) so that it is deposited on each of the sections (C): thereby, the same printing bar (31) simultaneously contributes to printing the image (I) matched to the shape (F) of each section (C) in transit below the printing bar (31) in the conveyance direction (T).

The printing unit (3) can also operate on sections (C) arranged differently on the mobile table (P).

The technical result is a very high precision and efficient printing of a plurality of sections (C) conveyed by a mobile table (P) along a conveyance direction (T).

The sections (C) printed and output by the printing unit (3) are dried by means of a drying device (11) to allow the ink deposited on the glass to dry.

The drying device (11) may comprise UV or IR lamps directed towards the mobile table (P); alternatively, the drying can occur through ventilation means configured to direct an air blade from above to below, towards the printed section (C).

In an alternative embodiment, shown in FIG. 3, the drying can occur at the same time as the printing operation, interspersing drying devices such as IR or UV lamps or fans with the printing bars (31).

In an alternative embodiment, the sections (C) can undergo a heating step before the printing step: this pre-heating step, by means of a special pre-heating device (12), allows a faster drying of the ink, which is then dispensed by the printing unit (3); the pre-heating is particularly useful in applications where the dispensing of a thick layer of ink is required on the section (C), so as to obtain a highly opaque decoration, preventing the phenomenon of ink migration on the surface of the section (C).

Lastly, the printed and dried sections (C) are tempered by a special tempering device (15), known in the art, to obtain the vitrification of the ink and to obtain the final structural features of the section (C).

The system according to the present invention lastly comprises a quality control system (13).

The aforesaid quality control system (13) can be located upstream of the tempering device (15) considering the main conveyance direction (T), as illustrated in FIG. 1 and FIG. 2; alternatively, the quality control system (13) can be located downstream of the tempering device (15), considering the main conveyance direction (T).

In order to be able to monitor the printing quality of the image (I) on each section (C), and in order to monitor the operation of each device and machine present in the system (A), the quality control system (13) is configured to analyse each piece or section (C) output by the system (A) described in the previous paragraphs.

In fact, the quality control system (13) comprises a plurality of sensors, configured to acquire information related to each section (C).

A first example of control performed by the quality control system (13) relates to printing the image (I): a plurality of sensors, e.g., optical sensors, detect the image printed on the section (C) by the printing unit (3).

A comparison algorithm, integrated with the quality control system (13) allows the result of the printing operation on the section (C), detected by the optical sensors, to be compared with the original image (I), taking into account any modifications introduced for the adaptation to the real dimensions (D″) by the scaling (7) or trimming (8), and alignment (9) units. The information obtained from such a comparison is sent to a classifier (14), which is configured to translate the data transmitted by the comparison algorithm into a classification of the print obtained.

That is, following the comparison operations performed by the comparison algorithm integrated in the quality control system (13) and on the basis of pre-set tolerance thresholds, the classifier (14) is configured to attribute a category to each product output by the system (A); increasing categories indicate a greater difference between the expected result and the result obtained.

That is, for example, but not exclusively, the classifier (14) attributes a label to each section (C) output by the system (A), which is defined by a category: increasing category numbers indicate a deterioration in the performance of a device, in this case, the printing unit (3) with the related matching (5), scaling (7) or trimming (8), and alignment (9) units.

For example, increasing categories therefore indicate on a qualitative level the presence of an increasing number of defects.

In a preferred, but not exclusive, embodiment, the classifier (13) attributes to each section (C) and, consequently, to each printing event carried out by the printing unit (3), one of the following categories:
1—printed correctly, product conforms to the specifications;
2—printed with defects, product conforms to the specifications within a tolerance threshold;
3—printing with defects, product does not conform to the specifications.

Going from category 1 to category 3, the number of defects detected is increasing and increasingly influences the quality of the final product.

Other intermediate categories can be intuitively identified, depending on the specific requirements of each production process.

Furthermore, the control system (13) and the classifier (14) can be programmed and adapted to assess the quality of each step of the processing process of the sheets (L): suitably selected sensors detect appropriate quantities capable of characterising a specific production step. Advantageously, on the basis of the classification carried out by the classifier (14), the quality control system (13) is configured to emit a signal which can be intuitively interpreted by the line operator or by another production line management system.

Furthermore, the quality control system (13) is configured to send retroactive commands to the plurality of devices and units comprised in the production line of the system (A), so as to correct any operating errors which lead to the presence of final products of a quality which does not conform to the desired specifications.

That is, the quality control system (13) detects parameters by means of sensors, communicates comparison values to the classifier (14) and, based on the attributed classification, communicates in feedback with each device or unit of the processing line of the system (A) so as to improve the production process.

Advantageously, thanks to the introduction of the quality control system (13) and the classifier (14), it is possible to reduce the number of non-conforming final products, and thus to be discarded, or of conforming but not perfect final products.

It should be noted that the non-conformities can concern substantial elements, which affect the performance of the final product, or marginal elements, which do not affect the performance of the final product, but which nevertheless render it not perfectly compliant with the specifications: the quality control system (13) is configured to recognise the difference between the two non-conformities and to send operational commands with different priorities and modalities on the basis of the non-conformities detected.

The processing system according to the present invention, illustrated above in a preferred but not exclusive embodiment, advantageously allows to efficiently cut a plurality of sections (C) from a sheet (L), to print the plurality of sections (C), to reduce the amount of scrap elements and waste, to increase the printing quality, ensuring a high level of accuracy, to decrease the processing time and to correct the presence of any errors and malfunctions within the different steps of the production line, making the process more efficient.

1) A high efficiency processing system for sheets, comprising:
a mobile table, having a conveyance direction;
a device for cutting sections having a shape and real dimensions from a sheet having a surface and comprising an optimisation algorithm integrated with a cutting means;
a machining device configured to perform machining of the surface or through the thickness of each section of the shape; and
a printing unit configured to receive as input a set of images of expected dimensions and to dispense ink onto each section of the shape, wherein the printing unit is situated downstream of the cutting device considering the conveyance direction;
a drying device configured to bring about the drying of the ink dispensed onto each section;
wherein the printing unit comprises:
a recognition unit comprising a plurality of sensors configured to detect the shape and real dimensions of each section;
a matching unit configured to match an image belonging to the set of images to the shape of each section detected by the recognition unit;
an alignment unit configured to detect the presence of a rotation angle between the section and the main conveyance direction; and
a control unit configured to receive as input the image or the trimmed image, the expected dimensions, the real dimensions, and the angle for each section and to send operating commands to the printing unit;
at least one among:
a scaling unit, integrated with a scaling algorithm and configured to adapt the expected dimensions of the image to the real dimensions of each section detected and transmitted to the scaling unit by the recognition unit;
a trimming unit, integrated with a trimming algorithm, operating alternately with the scaling algorithm of the scaling unit, and configured to receive as input the real dimensions of each section transmitted by the detection unit and to compute a trimmed image based on the image.

2) The processing system according to claim 1, wherein the printing unit comprises at least one printing bar, located above the mobile table, which comprises a plurality of nozzles configured to dispense ink towards the mobile table, and wherein the dispensing of ink from above to below by the nozzles belonging to a printing bar identifies a printing front perpendicular to the conveyance plane.

3) The processing system according to claim 2, wherein the printing front extends for a width, measured along a horizontal transverse direction perpendicular to the conveyance direction, and sufficient to be positioned above two or more sections placed side by side along the transverse direction.

4) The processing system according to claim 1, wherein the recognition unit comprises a plurality of image sensors configured to detect the shape of each section.

5) The processing system according to claim 4, wherein the recognition unit transduces the shape of the section into a shape signal.

6) The processing system according to claim 5, wherein the recognition unit transmits the shape signal to the matching unit.

7) The processing system according to claim 1, wherein the scaling unit is configured to transmit to the control unit the expected dimensions of the image if the expected dimensions of the image and the real dimensions of the section coincide; or
transmit to the control unit the real dimensions of a new image given by the adaptation of the image to the real dimensions if the real dimensions of the section and the expected dimensions of the image do not coincide.

8) The processing system according to claim 1, wherein, if the real dimensions are smaller than the expected dimensions, the trimming unit will trim the edges of the image, thereby obtaining a trimmed image having the real dimensions

9) The processing system according to claim 1, wherein the trimming unit transmits the trimmed image to the control unit.

10) The processing system according to claim 1, comprising a quality control unit comprising a plurality of sensors and integrated with a classifier, said quality control unit being configured at least to:
detect parameters of interest of each section output by the processing system;
compare the values of the parameters of interest detected for each section with pre-set optimal values of the aforesaid parameters of interest;
attribute to each section output by the processing system a classification based on the comparison between detected values and optimal values of the parameters of interest detected;
send retroactive operating commands, differentiated according to the classification attributed by the classifier, said operating commands being directed to one or more of: a cutting device, machining device, printing unit, drying device, recognition unit, matching unit, scaling unit or trimming unit, alignment unit and control unit.
